(19) United States
(12) Patent Application Publication
(10) Pub. No.: US 2014/0373940 A1
(43) Pub. Date: Dec. 25, 2014

(54) FLUID DRAIN MANIFOLD

(71) Applicant: Caterpillar Inc., Peoria, IL (US)

(72) Inventors: Sorin G. Toader, JR., Oswego, IL (US); Eric P. Jakubiak, Aurora, IL (US)

(21) Appl. No.: 13/922,557

(22) Filed: Jun. 20, 2013

(51) Int. Cl. F16L 55/07; F15B 21/00

(52) U.S. Cl. CPC F16L 55/07; F15B 21/005
USPC 137/267; 137/266

(57) ABSTRACT

A fluid drain manifold is disclosed. The fluid drain manifold can include a manifold body and a plurality of hollow interior channels extending through an interior of the manifold body between an upper end and a bottom end of the manifold body. The plurality of hollow interior channels can include a plurality of individual drain line channels and an outlet channel. The outlet channel can be disposed within the interior of the manifold body, and the outlet channel can include an upper end and an open lower, outlet end. The open lower outlet end of the outlet channel can be positioned at the bottom end of the manifold body. Each of the plurality of individual drain line channels can include an open upper, inlet end at the upper end of the manifold body and an open lower, outlet end fluidly connected to the outlet channel.

### TECHNICAL FIELD

The present disclosure relates to a manifold, and more particularly, to a fluid drain manifold.

### BACKGROUND

Fluid manifolds may be utilized for numerous purposes, such as to channel, combine, divert, and/or otherwise direct the flow of fluid in a wide variety of fluid systems, configurations, or applications. In particular, in certain fluid systems, including but not limited to hydraulic fluid systems, a fluid manifold may be incorporated into the system to facilitate the drainage of fluid from system components into a fluid collection reservoir, such as a tank. However, due to a variety of factors, fluid drain manifolds may present disadvantages, difficulties, limitations, and/or undesirable effects which may include and/or arise as a result of or in relation to any one or more of system component failure, debris and/or fluid cross contamination, fluid and/or fluid contamination monitoring, and others.

U.S. Pat. No. 4,177,016 (the '016 patent) to Aude, discloses a self cleaning manifold connection for a slurry pump. One or a plurality of positive displacement slurry pumps are connected to common intake and discharge manifolds at a typical slurry pipeline pumping station. Each pump is connected at its inlet by inlet piping from the intake manifold through an intake isolation valve with a flushing water inlet between the intake isolation valve and the pump. Additionally, each pump is connected at its outlet by outlet piping to the outlet manifold through an outlet isolation valve with a pump drain between the outlet isolation valve and the pump. Conventional pulsation dampeners are connected to the piping at least at the discharge manifold and communicate a volume of gas under pressure to the pump for dampening of shock waves. Each inlet and outlet piping has a respective pipe length and slope between the pump on the high side to the station intake manifold and to the discharge manifold on the low side. Settlement of virtually all of the particulate matter of the slurry clear of the intake and discharge isolation valves occurs when the pump is off.

The present disclosure is directed to mitigating or eliminating one or more of the drawbacks discussed above.

### SUMMARY

One aspect of the present disclosure is directed to a fluid drain manifold. The fluid drain manifold can include a manifold body and a plurality of hollow interior channels extending through an interior of the manifold body between an upper end and a bottom end of the manifold body. The plurality of hollow interior channels can include a plurality of individual drain line channels and an outlet channel. The outlet channel can be disposed within the interior of the manifold body, and the outlet channel can include an upper end and an open lower, outlet end. The open lower outlet end of the outlet channel can be positioned at the bottom end of the manifold body. Each of the plurality of individual drain line channels can include an open upper, inlet end at the upper end of the manifold body and an open lower, outlet end fluidly connected to the outlet channel.

Another aspect of the present disclosure is directed to a fluid system. The fluid system can include a plurality of individual fluid sources, a fluid drain manifold and a plurality of fluid drain lines. Each of the plurality of individual fluid sources can include a housing. The fluid drain manifold can include a manifold body and a plurality of hollow interior channels extending through an interior of the manifold body. The plurality of hollow interior channels can include a plurality of individual drain line channels and an outlet channel. Each of the plurality of individual drain line channels can extend from an open upper, inlet end at an upper end of the manifold body to an open lower, outlet end fluidly connected to the outlet channel within interior of the manifold body. The outlet channel can include an open lower outlet end positioned at the bottom end of the manifold body. Each of the plurality of fluid drain lines can include an inlet end and an outlet end. The inlet end of each of the plurality of fluid drain lines can be connected in fluid communication to a housing of one of each of the plurality of individual fluid sources. The outlet end of each of the plurality of fluid drain lines can be connected in fluid communication to an open upper, inlet end of one of each of the plurality of individual drain line channels.

Yet another aspect of the present disclosure is directed to a machine. The machine can include at least one frame, a fluid system, and a tank. The fluid system can include a plurality of individual fluid sources. The machine can also include a fluid drain manifold mounted on at least one frame of the machine and fluidly connected between the plurality of individual fluid sources and the tank. The fluid drain manifold can include a manifold body and a plurality of hollow interior channels extending through an interior of the manifold body between an upper end and a bottom end of the manifold body. The plurality of hollow interior channels can be configured to receive a plurality of individual flows of fluid each fluidly communicated to the upper end of the manifold body from the plurality of individual fluid sources and channel and consolidate each of the plurality of individual flows of fluid within the manifold body into a single, combined outlet flow of fluid flowing out of the bottom end of the manifold body.

### BRIEF DESCRIPTION OF THE DRAWINGS

FIG. 1 is a perspective view of an exemplary disclosed fluid drain manifold;

FIG. 2 is a sectional view of an exemplary disclosed fluid drain manifold; and

FIG. 3. is a schematic view and diagrammatic illustration of an exemplary machine including an exemplary disclosed fluid system and fluid drain manifold incorporated therein.

### DETAILED DESCRIPTION

The present disclosure is directed to a fluid drain manifold which can be incorporated as a component of any fluid system, fluid circuit or circuits, fluid network, and/or configuration or combination thereof in which a fluid drain manifold consistent with any one or more of the embodiments disclosed herein can be employed. In particular, in addition to embodiments directed to the presently disclosed fluid drain manifold, at least one additional embodiment of the present disclosure is directed to an exemplary fluid system which can be included as a system of a machine and incorporates at least one fluid drain manifold according to any of the embodiments of the present fluid drain manifold as disclosed herein. Reference now will be made in detail to exemplary embodiments that are illustrated in the accompanying drawings. Wherever possible, the same reference numbers will be used throughout the drawings to refer to the same or like parts.

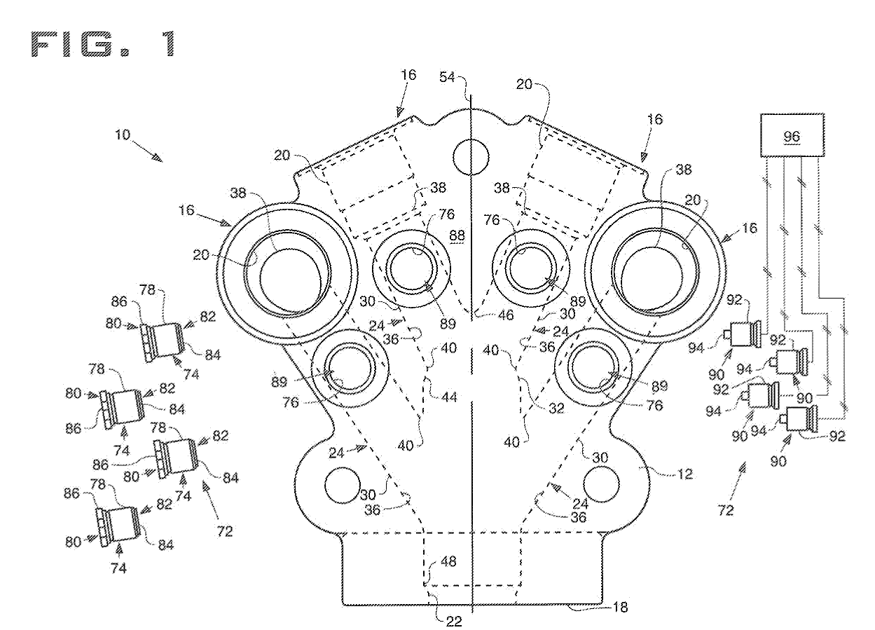

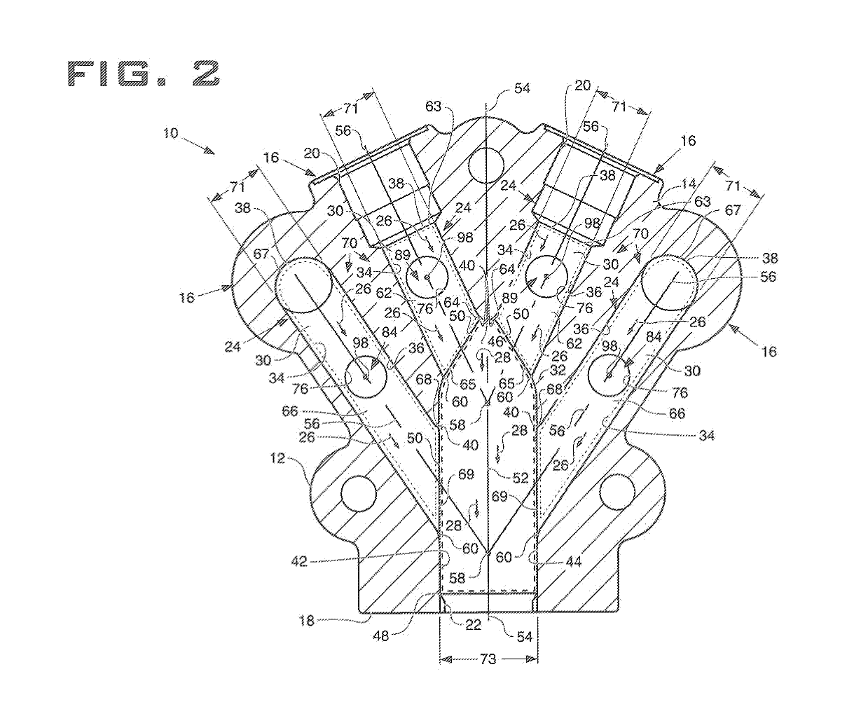

An exemplary embodiment of a fluid drain manifold 10 is illustrated in FIG. 1 and FIG. 2. The fluid drain manifold 10 can include a manifold body 12, which in one embodiment, is a substantially solid, unitary manifold body 12 which can be composed of a hard, durable material, including but not limited to iron, steel, metallic compositions including alloys of iron, steel, or other metallic materials, or any other suitable known metallic or non-metallic material. Additionally, in one embodiment, the substantially solid, unitary manifold body 12, and the features thereof and included therein according to any one or more embodiments of the present disclosure can be manufactured through a casting process as a cast manifold body 12. Alternatively, the substantially solid, unitary manifold body 12, and the features thereof and included therein according to the present disclosure can be fabricated via one or more machining operations as a machined manifold body 12. The manifold body 12 can include an interior 14, an upper end 16 and a bottom end 18 generally opposite of the upper end 16. In one embodiment, the upper end 16 of the manifold body 12 can include a plurality of inlet ports 20, and the bottom end 18 of the manifold body 12 can include a at least one outlet port 22. The fluid drain manifold 10 can also include a plurality of hollow interior channels 24 disposed within and extending through the interior 14 of the manifold body 12 between the upper end 16 and the bottom end 18 thereof. As further provided herein, the plurality of hollow interior channels 24 can be configured, in part, to form a network of fluid pathways extending through the manifold body 12 which can receive a plurality of individual flows of fluid 26 from a plurality of individual fluid sources (as disclosed further herein) fluidly communicated into the hollow interior channels 24 at the upper end 16 of the manifold body 12, channel the individual flows of fluid 26 through the manifold body 12, consolidate the individual flows of fluid 26 within the manifold body 12 into at least one combined outlet flow of fluid 28, and in one embodiment, a single, combined outlet flow of fluid 28, and fluidly direct the outlet flow of fluid 28 out of the bottom end 18 of the manifold body 12.

In particular, the plurality of hollow interior channels 24 can include a plurality of individual drain line channels 30 as well as an outlet channel 32. Each individual drain line channel 30 can include an interior flow volume 34, a channel wall 36, an upper, inlet end 38, and a lower, outlet end 40. In one embodiment, each individual drain line channel 30, and the interior flow volume 34 thereof, can be defined as an open passage formed within the interior 14 of the solid manifold body 12 by the channel wall 36 of each individual drain line channel 30 extending between an open upper, inlet end 38 and an open lower, outlet end 40 thereof. Similarly, the outlet channel 32 can include an interior flow volume 42, a channel wall 44, an upper end 46 and a lower, outlet end 48, wherein in one embodiment, the outlet channel 32, and the interior flow volume 42 thereof, can be defined as an open passage formed within the interior 14 of the solid manifold body 12 by the channel wall 44 of the outlet channel 32 extending between an upper end 48 and an open lower, outlet end 48 thereof.

As illustrated in FIG. 1 and further illustrated in FIG. 2, the open upper, inlet end 38 of each individual drain line channel 30 can be positioned at the upper end 16 of the manifold body 12 to receive an individual flow of fluid 26. In one embodiment, the open upper, inlet ends 38 of the individual drain line channels 30 can each be associated and connected in fluid communication with one of each of the plurality of inlet ports 20 at the upper end 16 of the manifold body 12. The lower, outlet end 40 of each individual drain line channel 30, and channel wall 36 thereof, can be fluidly connected to intersect with, open into, and form an opening 50 in the channel wall 44 of the outlet channel 32, as shown in the exemplary embodiment illustrated in FIG. 2. The upper end 46 of the outlet channel 32 can be positioned within the interior 14 of the manifold body 12, and the open, lower, outlet end 48 of the outlet channel 32 can be positioned at the bottom end 18 of the manifold body 12 to direct a combined outlet flow of fluid 28 out of the interior 14 of the manifold body 12. In one embodiment, the open lower, outlet end 48 of the outlet channel 32 can be connected in fluid communication with the outlet port 22 at the bottom end 18 of the manifold body 12. As further provided herein, the outlet channel 32, and the interior flow volume 42 thereof can be sized, positioned, oriented, and/or otherwise configured, in part, to receive each of the individual flows of fluid 26 fluidly communicated out of the lower, outlet ends 40 of the individual drain line channels 30 and fluidly, progressively, and uni-directionally communicate, consolidate, and direct each of the individual flows of fluid 26 downward and out of the bottom end 18 of the manifold body 12 into a single, combined outlet flow of fluid 28 as the outlet channel 32 extends from its upper end 46 to its lower, outlet end 48. In one embodiment, the outlet channel 32, and the interior flow volume 42 thereof, can extend substantially vertically within the interior 14 of the manifold body 12 along a center vertical axis 52. In an additional embodiment, the center vertical axis 52 of the outlet channel 32 can be aligned with a center vertical axis 54 of the manifold body 12, and thus, in one example, the interior flow volume 42 of the outlet channel 32 can be centrally located within the interior 14 of the manifold body 12 to extend substantially vertically and directly downward toward its open, lower, outlet end 48 at the bottom end 18 of the manifold body 12. In other embodiments, the interior flow volume 42 of the outlet channel 32 can be positioned within the interior 14 of the manifold body 12 in other orientations to provide, in part, a smooth, unidirectional, and gravity-assisted flow of fluid therethrough without departing from the spirit or scope of the present disclosure.

The individual drain line channels 30 and the outlet channel 32 can be sized, positioned, and/or configured to provide, in part, a smooth, unidirectional, and gravity-assisted flow of fluid through the interior 14 of the manifold body 12 from the upper end 16 to the bottom end 18 thereof. In particular, in one embodiment, each individual drain line channel 30 can be positioned and oriented within the interior 14 of the manifold body 12 such that the interior flow volume 34 and flow path of an individual flow of fluid 26 therethrough can be increasingly directed toward the interior flow volume 42 (and in one example, the center vertical axis 52) of the outlet channel 32 and the bottom end 18 of the manifold body 12 as each individual drain line channel 30 extends from its open upper, inlet end 38 at the upper end 16 of the manifold body 12 to its open lower, outlet end 40 fluidly connected to the outlet channel 32. In one example, each individual drain line channel 30, and interior flow volume 34 thereof, can extend directly and substantially linearly from the upper end 16 of the manifold body 12 to the outlet channel 32 along a center axis 56. In an additional example, each individual drain line channel 30 can be defined as including a substantially linear interior flow volume 34 and center axis 56 which can extend directly and substantially vertically and/or at a vertically inclined angle toward the center vertical axis 52 of the outlet channel 32 as each individual drain line channel 30 extends from its open upper, inlet end 38 at the upper end 16 of the manifold body 12 to its open lower, outlet end 40 attached in fluid communication with the outlet channel 32. In one particular example, the center axis 56 of the interior flow volume 34 of each individual drain line channel 30 can intersect with and form an acute angle with the center vertical axis 52 of the outlet channel 32, wherein the angle formed between the center axis 56 of each individual drain line channel 30 and the center vertical axis 52 of the outlet channel 32 can be between 0° and 40°. Additionally, the orientation and position of each individual drain line channel 30 and interior flow volume 34 thereof can be configured to fluidly direct one of each of the plurality of individual flows of fluid 26 out of the open lower, outlet end 40 of each individual drain line channel 30 and into the interior flow volume 42 of the outlet channel 32 at an acute, substantially vertical and/or vertically inclined angle and flow path which can be angled downward toward the bottom end 18 of the manifold body 12. In particular, in one embodiment, the interior flow volume 34 and flow path of an individual flow of fluid 26 within each individual drain line channel 30 can be substantially vertical and/or vertically inclined and/or increasingly directed toward the outlet channel 32 such that each center axis 56 of each one of the plurality of individual drain line channels 30 intersects with the center vertical axis 52 of the outlet channel 32 at an intersection 58, wherein each intersection 58 between the center axis 56 of each one of the plurality of individual drain line channels 30 and the center vertical axis 52 of the outlet channel 32 can be formed at position within the interior flow volume 42 of the outlet channel 32 which is vertically below a bottom end 60 of the lower, outlet end 40 of the individual drain line channel 30 and thus, and accordingly, the bottom end 60 of the opening 50 between the lower, outlet end 40 of the individual drain line channel 30 and the outlet channel 32, as shown in FIG. 2. In other embodiments, each individual drain line channel 30 as well as the interior flow volume 34 and flow path of an individual flow of fluid 26 therethrough can be positioned and oriented within the interior 14 of the manifold body 12 in other orientations and/or configurations such that the individual drain line channels 30 fluidly directs each individual flow of fluid 26 into the interior flow volume 42 of the outlet channel 32 toward the bottom end 18 of the manifold body 12 smoothly, directly, and in a gravity-assisted, uni-directional manner.

In addition, the outlet channel 32 and the interior flow volume 42 thereof can be configured, in part, to receive each of the individual flows of fluid 26 fluidly communicated out of the lower, outlet ends 40 of the individual drain line channels 30 and fluidly and progressively communicate, consolidate, and direct each of the individual flows of fluid 26 downward and out of the bottom end 18 of the manifold body 12 into a single, combined outlet flow of fluid 28 as the outlet channel 32 extends from its upper end 46 to its lower, outlet end 48. As such, the upper end 46 of the outlet channel 32 can be defined as the upstream end of the outlet channel 32, and the lower, outlet end 48 can be defined as the downstream end of the outlet channel 32. Additionally, the lower, outlet ends 40 of the individual drain line channels 30 can be fluidly connected to intersect with and open into (and, as provided above, form openings 50 in) the channel wall 44 of the outlet channel 32 at one of various positions along the length of the outlet channel 32, including at or proximate to the upstream, upper end 46 of the outlet channel 32, and between the upstream, upper end 46 and the downstream, lower, outlet end 48 of the outlet channel 32. Furthermore, the upper, inlet ends 38 of the individual drain line channels 30 can be positioned at the upper end 16 of the manifold body 12 at one of various positions including substantially vertically aligned with the center vertical axis 52 of the outlet channel 32, proximate to the center vertical axis 52 of the outlet channel 32, and at various outwardly spaced radial and/or lateral distances from the center vertical axis 52 of the outlet channel 32. As a result, in order to provide a smooth, unidirectional, and gravity-assisted, and in one embodiment, a substantially vertical, flow of fluid through the interior 14 of the manifold body 12, the position at which the lower, outlet end 38 of each individual drain line channel 30 can intersect with and form an opening 50 in the channel wall 44 of the outlet channel 32 can be defined by the radial and/or lateral distance between the center vertical axis 52 of the outlet channel 32, and in one embodiment, the center vertical axis 54 of the manifold body 12, and the position of the upper, inlet end 38 of each individual drain line channel 30 at the upper end 16 of the manifold body 12 such that the flow path of fluid 26 through the interior flow volume 34 of each individual drain line channel 30 can be increasingly directed, and in one embodiment, can be substantially vertical and/or vertically inclined toward and increasingly directed toward the center vertical axis 52 of the outlet channel 32 according to any one or more of the embodiments as provided herein.

In an exemplary embodiment shown in FIG. 1 and FIG. 2, one or more first individual drain line channels 62 can each extend between an upper, inlet end 63 (and in one embodiment, an associated inlet port 20) positioned at the upper end 16 of the manifold body 12 at or proximate to the center vertical axis 52 of the outlet channel 32, and a lower, outlet end 64 which intersects with, and forms an opening 65 in the channel wall 44 of the outlet channel 32 at or proximate to the upstream upper end 46 thereof. As further illustrated in the exemplary embodiment of FIG. 1 and FIG. 2, one or more second individual drain line channels 66 can each extend between an upper, inlet end 67 (and in one embodiment, an associated inlet port 20) at the upper end 16 of the manifold body 12 but positioned radially and/or laterally outward from the center vertical axis 52 of the outlet channel 32 (as well as the upper, inlet ends 63 of the one or more first individual drain line channels 62) and a lower, outlet end 68 which forms an opening 69 in the channel wall 44 of the outlet channel 32 between the upstream, upper end 46 and the downstream, lower, outlet end 48 of the outlet channel 32, downstream of the lower, outlet ends 64 of the one or more first individual drain line channels 62. In this manner, the illustrations as shown in FIG. 1 and FIG. 2 provide an example of one possible arrangement of individual drain line channels 30 positioned within the interior 14 of the manifold body 12 to fluidly connect with and extend between the upper end 16 of the manifold body 12 and the outlet channel 32 to form one or more arrays 70. In particular, in the illustrated example, each array 70 can include two or more adjacent substantially vertically and/or vertically inclined individual drain line channels 62, 66 arranged in incrementally and outwardly spaced relation with reference to the center vertical axis 52 of the outlet channel 32, and in one example, the center vertical axis 54 of the manifold body 12 and having lower, outlet ends 64, 68 intersecting with and opening into the interior flow volume 42 of outlet channel 32 at various positions along the length thereof.

However, the scope of the present disclosure is not limited to the foregoing exemplary embodiment, as the presently disclosed fluid drain manifold 10 can include additional or fewer adjacent and/or non-adjacent individual drain line channels 30 which can form additional or fewer arrays or other arrangements of individual drain line channels 30 which each have lower outlet ends 40 which intersect with and form an opening 50 in the channel wall 44 of the outlet channel 32 at a position defined by the radial and/or lateral distance between the center vertical axis 52 of the outlet channel 32 and the position of the upper, inlet end 38 of each individual drain line channel 30. Furthermore, in one embodiment the present fluid drain manifold 10 can additionally include an individual drain line channel 30 which can extend from an upper, inlet end 38 to a lower, outlet end 40 along an interior flow volume 34 having a center axis 56 which is coaxially aligned with the center vertical axis 52 of the outlet channel 32 such that the lower, outlet end 38 of the vertically aligned individual drain line channel 30 intersects with and forms an opening 50 at the upper end 46 of the outlet channel 32. Additionally, in an alternative embodiment, one or more of the individual drain line channels 30 may include and extend along a contoured or curved interior flow volume 34 which can be positioned and oriented within the interior 14 of the manifold body 12 such that the interior flow volume 34 and flow path of an individual flow of fluid 26 therein can be increasingly sloped and directed toward the central vertical axis 52 the outlet channel 32 and the bottom end 18 of the manifold body 12 as each individual drain line channel 30 extends from its upper, inlet end 38 at the upper end 16 of the manifold body 12 to its lower, outlet end 40 fluidly connected to the outlet channel 32 without departing from the spirit and scope of the present disclosure.

In one embodiment, in addition to the positions, orientations, and/or further fluid interactions between the individual drain line channels 30 and the outlet channel 32 to provide, in part, a smooth, unidirectional, and gravity-assisted flow of fluid through the interior 14 of the manifold body 12 from the upper end 16 to the bottom end 18 thereof according to any one or more of the embodiments as provided above and further provided herein, the individual drain line channels 30 and the outlet channel 32 can additionally be sized and/or otherwise configured to provide, in part, a smooth, unidirectional, and gravity-assisted flow path of fluid through the interior flow volume 42 and out of the open lower, outlet end 48 of the outlet channel 32. In particular, the interior flow volume 34 and channel wall 36 of each of the plurality of hollow interior channels 24 can include and can be defined by a flow area which can be defined by a diameter 71 of each of the plurality of hollow interior channels 24. Additionally, the interior flow volume 42 and channel wall 44 including but not limited to the open lower, outlet end 48 of the outlet channel 32 can include and can be defined by a flow area which can be defined by a diameter 73 of the outlet channel 32, wherein the diameter 73 of the outlet channel 32 including but not limited to the outlet end 48 thereof can be sized with respect to the diameter 71 of each of the plurality of hollow interior channels 24 such that the outlet channel 32 can be defined as including a lower flow resistance and increased flow area and diameter 73 than that of each of the plurality of hollow interior channels 24. As such, the diameter 73 of the of the outlet channel 32 including but not limited to the outlet end 48 thereof can be larger than the diameter 71 of each of the plurality of hollow interior channels 24. In one example, the diameter 71 of each of the plurality of hollow interior channels 24 can be between 40% to 75% of the diameter 73 of the of the outlet channel 32. In another example, the diameter 71 of each of the plurality of hollow interior channels 24 can be between 50% to 65% of the diameter 73 of the of the outlet channel 32. In yet another example, the diameter 71 of each of the plurality of hollow interior channels 24 can be between 55% to 60% of the diameter 73 of the of the outlet channel 32. The fluid drain manifold 10 can also include a plurality of fluid sensing devices 72 operatively positioned to detect, sense and/or monitor various substances within and/or characteristics and properties of each individual flow of fluid 26 being fluidly communicated through each individual drain line channel 30. In one embodiment, the fluid sensing devices 72 can include a plurality of magnetic plugs 74 accessibly and removably received within a plurality of passages 76 formed within the manifold body 12 and extending into each of the individual drain line channels 30. Each magnetic plug 74 can include a plug housing 78 which can include and extend between an outer end 80 and an inner end 82, wherein the inner end 82 can include a magnetized surface 84. The outer end 80 of the plug housing 78 of each magnetic plug 74 can be shaped to form a gripping surface 86, which can be any one of a bolt-head, a gripping handle, knob, or other similar geometry to facilitate the insertion and removal of each magnetic plug 74 from an associated passage 76. Each passage 76 can be defined as a port which can extend from the exterior surface 88 of the manifold body 12 to an individual drain line channel 30 to form an opening 89 in the channel wall 36 thereof. Each of the plurality of magnetic plugs 74 and plug housings 78 thereof can be of a size and shape to correspond with and be matingly, securely, and removably received within one of each of the plurality of passages 76 such that when received therein, the magnetized surface 84 of the inner end 82 of each plug housing 78 can extend into and through the opening 89 and can be in contact with and engaged by an individual flow of fluid 26 flowing through the interior flow volume 34 of one of each of the individual drain line channels 30 to magnetically detect the presence of metallic debris within the each individual flow of fluid 26 being fluidly communicated therethrough. Additionally, the plug housings 78 can be of a size and shape such that when the plurality of magnetic plugs 74 are removably received within the plurality of passages 76, the gripping surface 86 at the outer end 80 of the plug housing 78 can accessibly protrude outward from the passage 76 as well as the exterior surface 88 of the manifold body 12.

In an alternative embodiment, the plurality of fluid sensing devices 72 can include a plurality of electrical fluid sensors 90 operatively positioned and configured to electronically sense, monitor, and/or detect various substances within and/or characteristics and properties of each individual flow of fluid 26 being fluidly communicated through each individual drain line channel 30. In one embodiment, each electrical fluid sensor 90 can include a sensor housing 92 which can be of a size and shape to matingly correspond with and, in one example, be accessibly and removably received within one of the plurality of passages 76 such that a sensing device 94 of each electrical fluid sensor 90 can be operatively positioned to detect various substances, characteristics and/or properties of each individual flow of fluid 26, including but not limited to the presence of metallic debris within the individual flow of fluid 26. Each electrical fluid sensor 90, and sensing device 94 thereof, can include an optical sensor, pressure sensor, infrared sensor, or any other known sensor capable of sensing and/or monitoring various characteristics and/or properties of each individual flow of fluid as provided herein. Each electrical fluid sensor 90 can additionally be connected in electronic communication with an electrical control unit 96 such that one or more electrical signals indicative of various characteristics and/or properties of the fluid being fluidly communicated through each individual drain line channel 30, including but not limited to the presence of metallic debris therein, can be electronically transmitted from the plurality of electrical fluid sensors 90 to the electrical control unit 96 and communicated to an operator via a signal and/or via a user interface (not shown) associated with a machine (such as machine 104, as disclosed herein) in response to fluid readings received by each electrical fluid sensor 90.

The fluid sensing devices 72 can extend into and/or be engaged by the interior flow volume 34 of each individual drain line channel 30 at a position to prevent any potential exposure or interference from any other flow of fluid within the fluid drain manifold 10, wherein in one embodiment, each fluid sensing device 72 is positioned to extend into and/or be engaged by the interior flow volume 34 of one of each of the individual drain line channels 30 upstream of the lower, outlet end 40 of each individual drain line channel 30. In an additional embodiment, each fluid sensing device 72 can be positioned and, in one example, can be removably received within one of each of the plurality of passages 76 which can form an opening in the channel wall 36 of each individual drain line channel 30 upstream of the lower, outlet end 40 and proximate to the midpoint 98 of each individual drain line channel 30, halfway in between the upper, inlet end 38 and the lower, outlet end 40 thereof. Additionally, or alternatively, some or all of the fluid sensing device 72 can be received within a passage 76 which can form an opening in the channel wall 36 of some or all of the individual drain line channels 30 at a position which is substantially horizontally aligned with the opening 50 (such as opening 65) between the lower, outlet end 40 of an adjacent and/or proximate, upstream individual drain line channel 30 (such as a first individual drain line channel 62, as shown in FIG. 2) and the outlet channel 32.

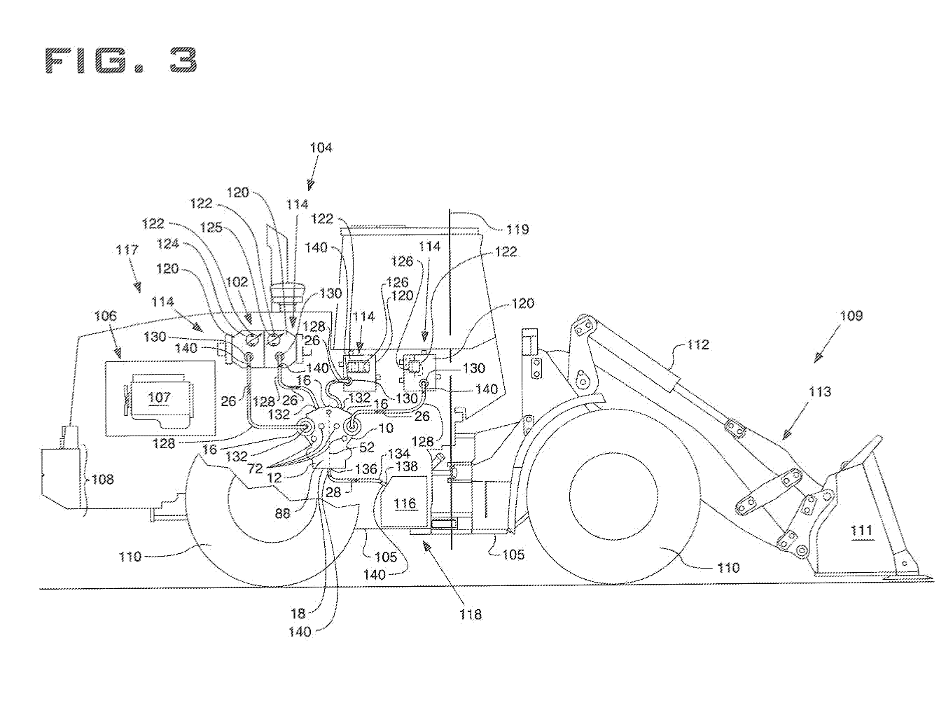

An exemplary embodiment of a fluid system 102 which not only can incorporate at least one fluid drain manifold 10 consistent with any one or more of the embodiments disclosed herein but also can be incorporated as a component of a machine 104 is illustrated in FIG. 3. In particular, in one example, the exemplary fluid system 102 and fluid drain manifold 10 included therein can be operatively incorporated in, used in connection with, and integrated, in whole or in part in any one or more systems of a machine 104. As illustrated by the exemplary embodiment shown in FIG. 3, the machine 104 can include at least one frame 105 and can be embodied as a moveable machine 104 including one or more systems that can facilitate the operation and movement of the machine 104, including but not limited to a power system 106 which can include an engine 107, as well as a drive system 108 and a work implement system 109 which can each be powered by the power system 106. The drive system 108 can propel the machine 104 on ground engaging devices 110 (depicted as wheels) to move the machine 104 from one location to another, and the work implement system 109 can include a work implement 111 as well as actuators 112 and linkages 113 to actuate the work implement 111 to perform various work functions. For the purposes of the present disclosure, by way of example and not by way of limitation, and to provide an exemplary illustration and description of the present fluid system 102 and fluid drain manifold 10, the fluid system 102 can be a fluid drainage system such as a hydraulic fluid drainage system and the machine 104 can be a wheel loader. However, the scope of the present disclosure is not limited to the foregoing exemplary embodiment and implementation, as the machine 104 may be any machine including but not limited to a crane, earthmoving vehicle, mining vehicle, backhoe, excavator, material handling equipment, dredger, or farming equipment. Alternatively, the machine 104 can be a stationary machine, such as an electric power generator or a pumping station for oil or gas (not shown). Furthermore, the fluid system 102 can be any drainage or other fluid system, hydraulic or otherwise which may implement or incorporate at least one presently disclosed fluid drain manifold 10.

According to the exemplary embodiment shown in FIG. 3, the fluid system 102 can include a plurality of individual fluid sources 114, at least one fluid drain manifold 10, and a tank 116. In one embodiment, the fluid drain manifold 10 can be mounted on or within a frame 105 of the machine 104 such that the upper end 16 of the manifold body 12 can be positioned in alignment with or otherwise oriented toward a top surface 117 of the machine 104 and the bottom end 18 of the manifold body 12 can be positioned in alignment with or otherwise oriented toward a bottom surface 118 of the machine 104. Additionally, in one example, the center vertical axis 52 of the outlet channel 32 and the center vertical axis 54 of the manifold body 12 can be vertically aligned with or parallel to a vertical axis 119 the machine 104.

The plurality of individual fluid sources 114 can each include a housing 120. In one embodiment, one or more of the plurality of individual fluid sources 114 can include a housing 120 and one or more fluid control device 122 housed therein. In one example, each fluid control device 122 can be a hydraulic pump 124, a hydraulic motor 125, a hydraulic valve 126, or any other fluid control device 122 which may be actuated or otherwise operable to control or influence any one or more of the movement, path, pressure, and/or flow of fluid within the fluid system 102. Alternatively, one or more or each of the plurality of individual fluid sources 114 can be embodied as and/or include any one or more of a manifold, a reservoir, a piston (such as a hydraulic piston), an actuator, and/or a separate fluid system. The fluid system 102 can also include a plurality of fluid drain lines 128, which can each be a flexible hose, tube, or any other suitable fluid conduit configured to fluidly direct an individual flow of fluid 26 therethrough, wherein each fluid drain line 128 can be connected to fluidly communicate an individual flow of fluid 26 from one of each of the plurality of individual fluid sources 114 to the upper end 16 of the fluid drain manifold 10. In particular, each fluid drain line 128 can extend from an inlet end 130 which can be attached in fluid communication to a housing 120 of an individual fluid source 114 to receive an individual flow of fluid 26 therefrom, to an outlet end 132 which can be attached in fluid communication to direct the individual flow of fluid 26 into an open upper, inlet end 38 of one of the plurality of individual drain line channels 30 (which can be via an associated inlet port 20) at the upper end 16 of the manifold body 12 of the fluid drain manifold 10. The fluid system 102 can also include a tank drain line 134, which can similarly be a flexible hose, tube, or any other suitable fluid conduit configured to fluidly direct a combined outlet flow of fluid 28 therethrough, wherein the tank drain line 134 can be connected in fluid communication to fluidly direct the combined outlet flow of fluid 28 from the bottom end 18 of the fluid drain manifold 10 to a tank 116. In particular, the tank drain line 134 can extend from an inlet end 136 attached in fluid communication to the open lower, outlet end 48 of the outlet channel 32 (which can be via the outlet port 22) at the bottom end 18 of the manifold body 12 of the fluid drain manifold 10, to an outlet end 138 of the tank drain line 134 attached in fluid communication to an inlet of the tank 116. Additionally, in one example, the inlet and outlet ends 130, 136 and 132, 138 of each of the fluid drain lines 128 and the tank drain line 134, respectively, can include adapters 140 to facilitate the secure, fluid connections between the foregoing respective drain lines 128, 140 and the housings 120, drain manifold 10, and in one embodiment, the tank 116. As shown in the schematic illustration of FIG. 3, the plurality of individual fluid sources 114 are schematically shown as positioned above the fluid drain manifold 10 for the purposes of illustrating the fluid connections between the plurality of individual fluid sources 114 and the fluid drain manifold 10, including but not limited to the fluid drain lines 128. However, the present disclosure is not limited to the schematic and diagrammatic illustration shown in FIG. 3, as one or more or each of the individual fluid sources 114 can be positioned below or substantially and/or partially at the same height or level as the fluid drain manifold 10 with the fluid drain lines 128 extending therebetween as shown in FIG. 3 without departing from the scope of the present disclosure.

### INDUSTRIAL APPLICABILITY

The fluid drain manifold 10 of the present disclosure may be incorporated as a component of any fluid system, fluid circuit or circuits, fluid network, and/or configuration or combination thereof in which a fluid drain manifold 10 consistent with any one or more of the embodiments disclosed herein can be employed. In addition to further advantages, the fluid drain manifold 10 according to any one or more of the embodiments as disclosed herein may provide a more efficient, smooth, gravity-assisted flow and consolidation of fluid therethrough, provide enhanced fluid flow properties and minimize backpressure. The presently disclosed fluid drain manifold 10 may also provide for a more convenient, accessible, accurate and reliable diagnosis and monitoring of various characteristics and/or properties of the fluid being fluidly communicated through the presently disclosed fluid drain manifold 10 as well as more convenient, accessible, accurate and/or reliable diagnosis and monitoring of the operation of the plurality of individual fluid sources and/or the one or more fluid control devices, while reducing and/or substantially eliminating the possibility of false diagnoses and/or readings. Furthermore, in addition to further advantages both as stated herein as well as those as understood by one of ordinary skill of the art upon being provided with the benefit of the teachings of the present disclosure, the fluid drain manifold 10 of the present disclosure may prevent any one or more of debris stagnation, fluid stagnation and fluid cross contamination, and any adverse effects which may be attributable thereto. Operation of the fluid drain manifold 10 will now be described. In particular, to provide an exemplary description of one possible implementation and/or operating environment of the present fluid drain manifold, the exemplary embodiment of a fluid drain manifold as illustrated in FIG. 1 and FIG. 2 will be described as a component of a fluid system 102 of a machine 104 as shown in FIG. 3.

Referring to FIG. 3 as well as FIG. 1 and FIG. 2, the fluid drain manifold 10 may be mounted on or within a frame 105 of a machine 104 and fluidly connected between a plurality of individual fluid sources 114 and a tank 116 of a fluid system 102, as provided according to any one or more of the embodiments disclosed herein. In one example, the fluid system 102 may be a fluid drainage system such as a hydraulic fluid drainage system, and each individual fluid source 114 may include one or more fluid control devices 122 including but not limited to any fluid control device 122 which may not only control or influence the flow of fluid within the fluid system 102 as disclosed above, but also may produce, generate, or otherwise cause an individual flow of fluid 26, which may include, in part, leakage, drainage, a flushing or relief flow of fluid, and/or any other individual flow of fluid 26 to be fluidly directed out of and/or away from the housing 120 of each individual fluid source 114. Alternatively, one or more or each of the plurality of individual fluid sources 114 can be a manifold, reservoir, piston (such as a hydraulic piston), actuator, a separate system, or any other component or source of an individual flow of fluid 26 without departing from the spirit and scope of the present disclosure.

In one example as shown in FIG. 3, each individual flow of fluid 26 from each individual fluid source 114 may be fluidly directed out of the housing 120 thereof and into an inlet end 130 of one of each of the plurality of fluid drain lines 128. Each of the individual flows of fluid 26 may next be fluidly communicated through each of the plurality of fluid drain lines 128 to the upper end 16 of the manifold body 12 of the fluid drain manifold 10 and directed into the plurality of hollow interior channels 24 disposed within and extending through the interior 14 of the substantially solid, unitary manifold body 12. As further illustrated by the exemplary embodiment shown in FIG. 1 and FIG. 2 as well as FIG. 3, upon being fluidly communicated to the fluid drain manifold 10, each individual flow of fluid 26 may be fluidly directed from the outlet end 132 of each fluid drain line 128 to flow into an open upper, inlet end 38 of one of each of the plurality of individual drain line channels 30 positioned at the upper end 16 of the manifold body 12. Once the individual flows of fluid 26 are fluidly directed into the individual drain line channels 30, each individual flow of fluid 26 may be fluidly communicated throughout the interior flow volume 34 of one of each of the individual drain line channels 30. In one embodiment, as each individual flow of fluid 26 is fluidly directed through the interior flow volume 34 of each individual drain line channel 30, each individual flow of fluid 26 may fluidly engage a magnetized surface 84 of a magnetic plug 74, or alternatively a sensing device 94 of an electrical fluid sensor 90, each disposed within a passage 76 which may form an opening 89 in the channel wall 36 of each individual drain line channel 32 upstream of and above the lower, outlet end 40 of each of the plurality of individual drain line channels 30.

Upon being fluidly communicated through the interior flow volume 34 of each individual drain line channel 30, each individual flow of fluid 26 may be fluidly directed out of the open lower, outlet end 40 of each individual drain line channel 30 to flow into the interior flow volume 42 of the outlet channel 32 through an opening 50 in the channel wall 44 of the outlet channel 32 at one of one or more various positions at and/or between the upstream, upper end 46 and the downstream, lower, outlet end 48 of the outlet channel 32. In one embodiment, as each individual flow of fluid 26 is fluidly directed into and downward through the interior flow volume 42 of the outlet channel 32 toward its lower, outlet end 48, each of the individual flows of fluid 26 can be consolidated with one or more upstream, downstream, proximate, and/or adjacent individual flows of fluid 26 such that each of the individual flows of fluid 26 can be progressively combined into a single, combined outlet flow of fluid 28 and directed downward and out of the bottom end 18 of the manifold body 12. The single, combined outlet flow of fluid 28 may next be fluidly directed into the inlet end 136 of the tank drain line 134 which may be attached in fluid communication to the lower, outlet end 48 of the outlet channel 32 (which may be via the outlet port 22) at the bottom end 18 of the manifold body 12 of the fluid drain manifold 10. The outlet flow of fluid 28 may next be fluidly communicated through the tank drain line 134 to the outlet end 138 thereof which may be attached in fluid communication to direct the outlet flow of fluid 28 into the tank 140.

As provided herein, the orientation, arrangement, and positioning of and between the plurality of individual drain line channels 30 and the outlet channel 32 within the interior 14 of the manifold body 12 of the fluid drain manifold 10 according to any one or more of the presently disclosed embodiments may provide a more efficient, smooth, substantially vertical, or otherwise gravity-assisted flow and consolidation of fluid therethrough while reducing or substantially eliminating debris cross contamination, and any adverse effects which may be attributable thereto. In particular, each individual flow of fluid 26 from any one or more of each of the plurality of individual fluid sources 114 of the fluid system 102 may include contaminants including but not limited to debris and/or foreign matter in the form of dirt, debris, aeration, or any other foreign solid, liquid, and/or gaseous contaminants entrained therein. Additionally, and in one example, any one or more of friction, wear, malfunction, and failure of a fluid control device 122 included in an individual fluid source 114 may cause metallic debris such as shavings to be introduced and fluidly entrained within an individual flow of fluid 26, discharged from the housing 120 of the fluid control device 122, and potentially fluidly communicated to contaminate one or more other individual flows of fluid 26 and cause the contamination, malfunction and/or failure of one or more associated individual fluid sources 114 and fluid control devices 122 within the fluid system 102.

In addition to providing a substantially vertical or otherwise gravity assisted flow of fluid, the fluid drain manifold 10 and the plurality of hollow interior channels 24 included therein can be configured and arranged, in part, to receive each separate, individual flow of fluid 26 from each individual fluid source 114 and channel, consolidate and direct each separate, individual flow of fluid 26 from each individual fluid source 114, and any debris therein, into a single, combined outlet flow of fluid 28 which may be directed unidirectionally and, and in one example, vertically, downward and out of the bottom end 18 of the manifold body 12 and away from any potential reintroduction into any individual flows of fluid 26 within the fluid system. In particular, and as provided by one or more of the exemplary embodiments of the present disclosure, the interior flow volume 34 of the outlet channel 32 can extend directly, and in one embodiment, substantially vertically, downward along a center vertical axis 52 toward its open, lower, outlet end 48 and the bottom end 18 of the manifold body 12, and in one example, can be centrally located within the interior 14 of the manifold body 12 to. Additionally, each individual drain line channel 30 can be configured to fluidly communicate each individual flow of fluid 26 throughout an interior flow volume 34 thereof which can define a flow path which can be inclined toward, and in one embodiment, can be substantially vertical and/or vertically inclined toward the outlet channel 32, and in one example, the central vertical axis 52 thereof, such that each individual flow of fluid 26 may be directed increasingly downward toward the bottom end 18 of the manifold body 12 and, in one example, increasingly inward toward the central vertical axis 52 of the centrally located outlet channel 32 as each individual flow of fluid 26 is fluidly communicated from the upper, inlet end 38 to the lower, outlet end 40 of each individual drain line channel 30. Furthermore, the orientation and position of each individual drain line channel 30 and interior flow volume 34 thereof as provided herein can be configured to fluidly direct each individual flow of fluid 26 out of the open lower, outlet end 40 of each individual drain line channel 30 and into the interior flow volume 42 of the outlet channel 32 downward toward the bottom end 18 of the manifold body 12. In particular, in one embodiment, the orientation and position of each individual drain line channel 30 and interior flow volume 34 thereof as provided herein can be configured to fluidly direct each individual flow of fluid 26 out of the open lower, outlet end 40 of each individual drain line channel 30 and into the interior flow volume 42 of the outlet channel 32 at an acute, substantially vertical and/or vertically inclined angle and flow path which can be angled downward toward the bottom end 18 of the manifold body 12

Thus, in addition to providing a smooth, unidirectional, and gravity-assisted flow of fluid through the interior 14 of the manifold body 12 from the upper end 16 to the bottom end 18 thereof, the plurality of individual drain line channels 30 and the outlet channel 32 may be oriented, arranged, and positioned, in part, to prevent debris stagnation and/or fluid stagnation within the interior 14 of the manifold body 12. In addition, and in particular, the vertically and downwardly angled orientation, arrangement, positioning and flow path of and between the plurality of individual drain line channels 30 and the outlet channel 32 as provided above may prevent any one or more individual flows of fluid 26 fluidly directed out of one or more individual drain line channels 30, 62, 66 or a combined outlet flow of fluid 28 within the outlet channel 32, and any debris or other foreign matter contained therein, from being fluidly directed or communicated into to cross contaminate any other individual flow of fluid 26 within the interior flow volume 34 of any other one or more other proximate, adjacent, upstream, and/or downstream individual drain line channels 30, 62, 66, as well as any subsequent communication, exposure, and resultant damage to any associated upstream fluid control devices 122 and/or individual fluid sources 114. Additionally, and as provided by any one or more of the embodiments as discussed above, the diameter 73 of the outlet channel 32 including but not limited to the outlet end 48 thereof can be sized with respect to the diameter 71 of each of the plurality of hollow interior channels 24 such that the outlet channel 32 can be defined as including a lower flow resistance and increased flow area and diameter 73 than that of each of the plurality of hollow interior channels 24. As a result, the lower flow resistance and increased flow area and diameter 73 of the outlet channel 32 including but not limited to the outlet end 48 thereof may provide a configuration wherein any contamination including but not limited to debris which may be present in any one or more individual flows of fluid 26 fluidly directed out of one or more individual drain line channels 30, 62, 66 may not be fluidly communicated into any other one or more other proximate, adjacent, upstream, and/or downstream individual drain line channels 30, 62, 66 but instead may be directed into, though, and out of the outlet channel 32 and the outlet end 48 thereof. Furthermore, any one or more of the foregoing features according to any one or more of the foregoing embodiments, including but not limited to the gravity assisted, downward, and in one example, the substantially vertical flows of fluid out of each of the individual drain line channels 30 fluidly directed into the outlet channel 32 and downward and out of the bottom end 18 of the manifold body 12, as well as the flow resistance between the individual drain line channels 30 and the outlet channel 32, as provided above, may prevent or may substantially eliminate any debris or contamination within any one or more individual fluid flows 26 from being fluidly directed upward and/or against the downward and/or gravity assisted flows of fluid through the fluid drain manifold 10 (which may also be fluidly directed therethrough via the action of any associated pumps) into any other individual drain line channel 30 to potentially contaminate any upstream fluid control devices 122 or systems including but not limited to a pump or pump case or any other fluid control device. Additionally, and in one embodiment, the magnetized surface 84 of the magnetic plugs 74 which can extend into the individual drain line channels 30 and can magnetically engage each individual flow of fluid 26 may include a magnetic force or otherwise be configured to not only magnetically sense and monitor, as provided above and further provided herein, but also to magnetically catch, filter, or otherwise prevent metallic debris such as shavings within an individual flow of fluid 26 from any other individual drain line channel 30 from potentially contaminating any upstream fluid control devices 122 or systems as an additional barrier which may prevent debris cross contamination.

Furthermore, the present fluid drain manifold 10 may provide for a more convenient, accurate and reliable diagnosis and monitoring of each individual flow of fluid 26 and fluid control device 122 within the fluid system 102 while reducing or substantially eliminating false diagnoses and/or readings. In addition to the vertically and downwardly angled orientation, arrangement, positioning and flow path of and between the plurality of individual drain line channels 30 and the outlet channel 32 which may reduce or substantially eliminate fluid and debris cross contamination as provided above, the presently disclosed fluid drain manifold 10 which may be incorporated into the exemplary fluid system 102, may provide a separate and dedicated fluid drain line 128 as well as a separate and dedicated individual drain line channel 30 and fluid sensing device 72 provided therein for each individual flow of fluid 26 from each individual fluid source 114. Specifically, each of the fluid sensing devices 72 may be positioned within a dedicated and separate individual drain line channel 30 to sense, engage and/or monitor each individual flow of fluid 26 from each individual fluid source 114 upstream of and above the lower, outlet end 40 of each individual drain line channel 30, and any potential exposure or interference from any other flow of fluid within the fluid drain manifold 10. Consequently, each of the fluid sensing devices 72 may be positioned within each substantially vertical and/or vertically inclined individual drain line channel 30 upstream of and above the lower, outlet end 40 thereof and upstream of the flow path of the combined outlet flow of fluid 28 within the outlet channel 32 to reduce or prevent the occurrence of false or inaccurate diagnoses and/or readings on account of the introduction, exposure, and cross contamination of one or more individual flows of fluid 26, a combined outlet flow of fluid 28, or combinations thereof into the interior flow volume 34 of any one individual drain line channel 34 from any one or more other proximate, adjacent, upstream, and/or downstream individual drain line channels 30, 62, 66 and/or the outlet channel 32.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A fluid drain manifold, comprising:
a manifold body;
a plurality of hollow interior channels extending through an interior of the manifold body between an upper end and a bottom end of the manifold body;
the plurality of hollow interior channels including a plurality of individual drain line channels and an outlet channel;
the outlet channel disposed within the interior of the manifold body, the outlet channel including an upper end and an open lower, outlet end;
the open lower outlet end of the outlet channel positioned at the bottom end of the manifold body; and
each of the plurality of individual drain line channels including an open upper, inlet end at the upper end of the manifold body and an open lower, outlet end fluidly connected to the outlet channel.

2. The fluid drain manifold of claim 1 wherein each of the plurality of individual drain line channels includes a fluid sensing device positioned upstream of the open, lower outlet end of each the plurality of individual drain line channels.

3. The fluid drain manifold of claim 2 wherein each fluid sensing device is a magnetic plug, wherein each magnetic plug is removably disposed within one of each of a plurality of passages extending from an exterior surface of the manifold body to form an opening in a channel wall of one of each of the plurality of individual drain line channels.

4. The fluid drain manifold of claim 3 wherein each of the plurality of individual drain line channels includes an interior flow volume extending from the open upper, inlet end to the open lower, outlet end of each individual drain line channel.

5. The fluid drain manifold of claim 4 wherein each interior flow volume of each of the plurality of individual drain line channels is configured to direct an individual flow of fluid at least one of increasingly downward toward the bottom end of the manifold body and increasingly inward toward a center vertical axis of the outlet channel as each individual flow of fluid is fluidly directed from the open upper, inlet end to the open lower, outlet end of each individual drain line channel.

6. The fluid drain manifold of claim 3 wherein each of the plurality of individual drain line channels includes a center axis, wherein each of the plurality of individual drain line channels extends directly and substantially linearly from the upper end of the manifold body to the outlet channel along each center axis of each of the plurality of individual drain line channels.

7. The fluid drain manifold of claim 6 wherein each center axis of each of the plurality of individual drain line channels intersects with a center vertical axis of the outlet channel at an acute angle.

8. The fluid drain manifold of claim 6 wherein each lower, outlet end of the plurality of individual drain line channels intersects with and forms an opening in a channel wall of the outlet channel.

9. The fluid drain manifold of claim 1 wherein the manifold body is a unitary manifold body.

10. The fluid drain manifold of claim 9 wherein each of the plurality of individual drain line channels is at least one of substantially vertical and vertically angled toward a center vertical axis of the outlet channel.

11. The fluid drain manifold of claim 10 wherein the manifold body is a cast manifold body.

12. A fluid system, comprising:
a plurality of individual fluid sources, each of the plurality of individual fluid sources including a housing;
a fluid drain manifold including a manifold body and a plurality of hollow interior channels extending through an interior of the manifold body;
the plurality of hollow interior channels including a plurality of individual drain line channels and an outlet channel;
each of the plurality of individual drain line channels extending from an open upper, inlet end at an upper end of the manifold body to an open lower, outlet end fluidly connected to the outlet channel within interior of the manifold body;
the outlet channel including an open lower outlet end positioned at the bottom end of the manifold body;
a plurality of fluid drain lines each including an inlet end and an outlet end;
the inlet end of each of the plurality of fluid drain lines connected in fluid communication to a housing of one of each of the plurality of individual fluid sources; and
the outlet end of each of the plurality of fluid drain lines connected in fluid communication to an open upper, inlet end of one of each of the plurality of individual drain line channels.

13. The fluid system of claim 12 wherein the outlet channel extends vertically within the interior of the manifold body along a center vertical axis.

14. The fluid system of claim 13 wherein each of the plurality of individual drain line channels are configured to direct an individual flow of fluid from one of each of the plurality of individual fluid sources through the interior of the manifold body and into an interior flow volume of the outlet channel at an angle which is angled downward toward the bottom end of the manifold body.

15. The fluid system of claim 14 wherein the outlet channel is configured to receive each individual flow of fluid and progressively direct and consolidate each individual flow of fluid downward and out of the bottom end of the manifold body as a single, combined outlet flow of fluid.

16. The fluid system of claim 15 additionally comprising a tank drain line including an inlet end and an outlet end, the inlet end of the tank drain line connected in fluid communication to the open lower outlet end of the outlet channel, and the outlet end of the tank drain line connected in fluid communication to a tank.

17. The fluid system of claim 16 wherein the manifold body includes a plurality of passages, each passage extending from an exterior surface of the manifold body to form an opening in a channel wall of one of each of the plurality of individual drain line channels.

18. The fluid system of claim 17 additionally comprising a plurality of magnetic plugs, each magnetic plug removably disposed within one of each of the plurality of passages and including a magnetized surface extending into the opening in the channel wall of one of each of the plurality of individual drain line channels.

19. A machine, comprising:
at least one frame, a fluid system, and a tank;
the fluid system including a plurality of individual fluid sources;
a fluid drain manifold mounted on the at least one frame of the machine and fluidly connected between the plurality of individual fluid sources and the tank;
the fluid drain manifold including a manifold body and a plurality of hollow interior channels extending through an interior of the manifold body between an upper end and a bottom end of the manifold body; and
the plurality of hollow interior channels configured to receive a plurality of individual flows of fluid each fluidly communicated to the upper end of the manifold body from the plurality of individual fluid sources and channel and consolidate each of the plurality of individual flows of fluid within the manifold body into a single, combined outlet flow of fluid flowing out of the bottom end of the manifold body.

20. The machine of claim 19 wherein the manifold body includes a central vertical axis, the central vertical axis of the manifold body parallel to a vertical axis of the machine.
